(19) United States
(12) Patent Application Publication
(10) Pub. No.: US 2006/0096597 A1
(43) Pub. Date: May 11, 2006

(54) SWIVEL FILTER FOR USE WITH SLEEP APNEA AND OTHER RESPIRATORY EQUIPMENT INCLUDING ASSOCIATED INTERFACE SYSTEMS

(75) Inventor: Harold P. Amann, Sunset Hills, MO (US)

Correspondence Address: BLACKWELL SANDERS PEPER MARTIN LLP, 720 OLIVE STREET, SUITE 2400, ST. LOUIS, MO, 63101, US

(73) Assignee: HOME HEALTH MEDICAL EQUIPMENT INCORPORATED, D/B/A AG INDUSTRIES, Fenton, MO (US)

(21) Appl. No.: 10/904,412

(22) Filed: Nov. 9, 2004

(51) Int. Cl. A62B 23/02; A62B 7/10

(52) U.S. Cl. 128/205.27; 128/205.29

(57) ABSTRACT

A swivel filter assembly for use with a wide variety of different types of sleep apnea equipment and other respiratory, pressure and/or breathing devices including oxygen concentrators and ventilators, one end portion of the overall assembly being adaptable for coupling to a source for providing air or other gas to the filter assembly and the other end portion being engageable with tubing adaptable for conveying air or other gas away from the filter assembly. The end portion of the filter assembly engageable with associated tubing is freely rotatable relative to the rest of the assembly thereby enabling the tubing engaged therewith to freely swivel and rotate to prevent binding and crimping of the tubing during use by a patient. The present assembly includes a space or cavity for receiving a filter member, the filter member being positioned across the passageway extending through the overall assembly for removing contaminants from the air or other gas as the air or other gas passes through the filter assembly.

### BACKGROUND OF THE INVENTION

This invention relates generally to filter assemblies and, more particularly, to a filter swivel assembly for use with a wide variety of different types of equipment used in treating respiratory insufficiency and/or sleep apnea such as Continuous Positive Airway Pressure (CPAP) systems, oxygen concentrators, ventilators, and other pressure breathing systems including for use with the interface mask associated with such equipment.

Sleep apnea and other respiratory disorders are very common and affect millions of people. Sleep apnea is a common disorder in which breathing stops during sleep for some period of time usually ten seconds or more. There are two main types of sleep apnea. “Obstructive” sleep apnea is caused by a blockage of the airway, usually when the soft tissue in the rear of the throat collapses and closes during sleep. “Central” sleep apnea appears to be related to a malfunction of the brain's normal signal to the appropriate muscles which control breathing. In Central sleep apnea, the airway is not blocked. Despite the difference in the root cause of sleep apnea, people with untreated sleep apnea stop breathing repeatedly during their sleep, sometimes hundreds of times during the night and often for long periods of time. As a result, people who suffer from sleep apnea experience sleep which is extremely fragmented and of very poor quality. If left untreated, sleep apnea can cause high blood pressure and other cardiovascular disease, memory loss, hypertension, stroke, impotency, weight gain, cognitive dysfunction, headaches and even death.

Patients with Obstructive and Central sleep apnea are commonly treated through the use of a wide variety of devices which provide and deliver air under pressure to the nasal passageways of a patient. One such device is called a Continuous Positive Airway Pressure (CPAP) device which uses a mask in conjunction with a pump that work together to keep the airway open with air pressure during each inspiration. A typical CPAP device includes a blower which is attached to an interface mask by means of flexible tubing such that continuous air under pressure is being provided to the patient. FIG. 1 illustrates a conventional CPAP system configuration wherein the CPAP device 10 includes an outlet 12 for attachment to a conventional filter assembly 14 for purging any contaminants which may still exist in the air being supplied to the patient under pressure as it passes from the CPAP device 10 to the mask 20. Properly and effectively filtering the incoming air being supplied to the patient before it is introduced into the nasal passages of the patient via the mask 20 not only improves the overall efficiency of the CPAP device but it also improves and increases the quality of air being provided under pressure to the patient. This helps to prevent dryness of the nostril tissue and also prevents pollen and other contaminants from entering the nasal passageways for obvious reasons. The filter assembly 14 is connected to conventional CPAP tubing 16 which is attached at its opposite end to the interface mask 20 and associated headgear for use by the patient. A coupling or adapter 18 is typically provided at each opposite end of the tubing 16 to facilitate connection of the hose 16 to both the filter assembly 14 and the mask 20. When the filter element inside filter assembly 14 is dirty and needs to be replaced, the entire filter assembly 14 is discarded and a new filter assembly is connected to the system.

Separate, optional swivel fittings are available for attachment to some CPAP devices and/or some filter members and masks to facilitate movement of the hose 16 relative to the CPAP device and/or the mask 20 as a patient tosses and turns during sleep. If adaptable to the particular CPAP system being used, optional swivel fittings help minimize forces applied to the mask 20 and ultimately to the user's face and nose during sleep, and they help to prevent binding of the hose 16 during a patient's normal sleep cycle.

Masks and other headgear/interface systems used by patients in the treatment of sleep apnea or in other applications are recognized as the source of most discontent/discomfort, some of which is contributed to the forces being applied to the mask via the connecting hose as a patient tosses and turns during sleep. Although optional swivel fittings help to minimize these forces by allowing more flexibility and freer movement of the hose 16 relative to both the mask 20 and the CPAP device 10, these additional fittings add additional weight to the hose 16 and tend to restrict movement of the hose 16 as a patient tosses and turns during sleep.

It is therefore desirable to reduce the number of components between the CPAP device and the patient's mask or other delivery interface system and to provide a combination swivel fitting and filter for attachment to the CPAP system or other respiratory system between the supply of air flow under pressure and the patient's mask which not only provides and improves the air filtration process to the patient, but also improves patient comfort by allowing the connection hose to freely move as a patient tosses and turns during sleep.

Accordingly, the present invention is directed to a swivel filter which overcomes one or more of the problems set forth above.

### SUMMARY OF THE INVENTION

The present invention overcomes many of the shortcomings and limitations of the prior art CPAP systems and other breathing systems applications discussed above and teaches the construction and operation of a combination swivel filter assembly adaptable for use in a wide variety of different applications including for use with CPAP equipment and other respiratory, pressure and/or breathing devices including oxygen concentrators and ventilators. In one aspect of the present invention, the present filter assembly includes a plug member having one end portion adapted for mating with a CPAP device or other appropriate equipment and having its opposite end portion adapted for mating with a nut member. The nut member includes an area for receiving a filter member which is held in position within the nut member when the nut member is cooperatively engaged with the plug member. The opposite end portion of the nut member is adapted for cooperatively engaging a swivel member, the swivel member including a projection associated with one end portion thereof adapted to mate with and seat against a corresponding projection associated with the nut member such that the swivel member is held in cooperative engagement with the nut member but yet is free to rotate in a 360° direction relative to the nut member. The opposite end portion of the swivel member is adapted for receiving appropriate tubing for delivering air flow from the CPAP device or other air flow pumping equipment to the mask or other interface equipment being worn by the patient. The swivel member enables the tubing connected thereto to freely rotate in response to any head movement of the patient wearing the mask. This helps to prevent binding and crimping of the tubing or hose extending between the swivel filter assembly and the mask during normal tossing and turning of a patient during sleep.

Since the plug member and nut member are cooperatively engageable, and are preferably threadedly cooperatively engageable, these members can be easily and quickly disengaged thereby exposing the filter member for inspection and changing, if appropriate, at regular intervals. As a result, quick and easy access is provided to the filter member housed within the overall assembly; easy manipulation of the swivel filter members is provided; and quick and easy removal and re-installation of a new filter member is easily accomplished. In addition, since the swivel fitting includes the filter member, an additional filter member such as the bacteria filter 14 illustrated in FIG. 1 is eliminated and the forces applied to the hose or tubing via user movement is reduced and minimized. Also, when the filter member inside the present swivel filter assembly needs to be replaced, the entire assembly is not discarded, but reused, only the filter member housed therewithin being discarded and replaced.

In another aspect of the present invention, the present filter assembly includes a first member having a first passageway extending therethrough, a second member having a second passageway extending therethrough, and a filter member. The first member has one end portion adapted for mating with a source for providing air or other gas to the first member for passage therethrough, and has its opposite end portion engageable with the second member. In this embodiment, the first member can be comparable to the plug member described above. The second member includes an area for receiving a filter member and has one end portion engageable with the first member and has its opposite end portion engageable or adaptable for receiving appropriate tubing for conveying the air or other gas away from the second member. The opposite end portion of the second member is rotatable thereby enabling the tubing attached thereto to rotate freely when engaged therewith. In this particular embodiment, the second member can be comparable to a combination of the nut member and swivel member described above. The first and second passageways associated with the first and second members lie in communication with each other when the first and second members are cooperatively engaged and the filter member, which is received within the second member, extends across the first and second passageways when the first and second members are engaged with each other.

In still another aspect of the present invention, the present filter assembly includes a first member, a second member, a third member, and a filter member. The first member includes one end portion which is adaptable for engagement with either an air or other gas supply source, or with tubing for supplying air or other gas to the first member, and has its opposite end portion engageable with the second member. This first member can be comparable to the plug member described above. The second member includes one end portion engageable with the first member and has its opposite end portion engageable with the third member. The second member likewise includes a space associated therewith for receiving the filter member. This second member can be comparable to the nut member described above. The third member includes one end portion engageable with the second member and has its opposite end portion engageable with tubing adaptable for conveying air or other gas away from the third member, the third member being freely rotatable relative to the second member when engaged therewith. This third member can be comparable to the swivel member described above. When the first, second and third members are respectively engaged with each other, the overall assembly includes a passageway extending therethrough for allowing air or other gas from the appropriate source to pass therethrough. The filter member which is received within the space defined within the second member is positioned across this passageway at an intermediate location therealong so as to remove contaminants from the air or other gas as the air or other gas passes through the overall assembly. In this embodiment, the filter member is held in operative position within the second member by engagement of the first member with the second member.

The present swivel filter assembly is adaptable for connection both to CPAP equipment or other pressure or breathing systems including oxygen concentrators and ventilators as described above, and it is likewise adaptable for connection to the mask or other interface head gear typically worn by the patient when using this type of equipment. As a result, the present swivel filter assembly is versatile; it is easily attachable to the pressure or breathing pump supply and the interface mask system used in conjunction therewith; it reduces the weight and forces applied to the connecting tubing or hose; it reduces the overall number of components associated with the CPAP or other pressure and/or breathing system; and it provides easy and quick access to and removal of the filter member which is housed within the overall assembly.

### BRIEF DESCRIPTION OF THE DRAWINGS

For a better understanding of the present invention, reference may be made to the accompanying drawings.

FIG. 1 is a schematic diagram of a conventional CPAP system configuration including a CPAP device, a conventional filter assembly, conventional CPAP tubing, and a typical interface mask.

FIG. 2 is a perspective view of the present filter assembly constructed in accordance with the teachings of the present invention.

FIG. 3 is a cross-sectional view of the filter assembly of FIG. 2.

FIG. 4 is a perspective view of the plug member or first member associated with the filter assembly illustrated in FIG. 2.

FIG. 5 is a perspective view of the nut member or second member associated with the filter assembly illustrated in FIG. 2.

FIG. 6 is a cross-sectional view of the nut member or second member illustrated in FIG. 5.

FIG. 7 is a perspective view of the swivel member or third member associated with the filter assembly illustrated in FIG. 2.

FIG. 8 is a cross-sectional view of the swivel member or third member illustrated in FIG. 7.

FIG. 9 is a perspective view of the filter member associated with the filter assembly illustrated in FIG. 2.

FIG. 10 is a schematic diagram illustrating one method of operative use of the present filter assembly in a typical CPAP system.

FIG. 11 is a schematic diagram illustrating another method of operative use of the present filter assembly in a typical CPAP system.

### DETAILED DESCRIPTION OF THE INVENTION

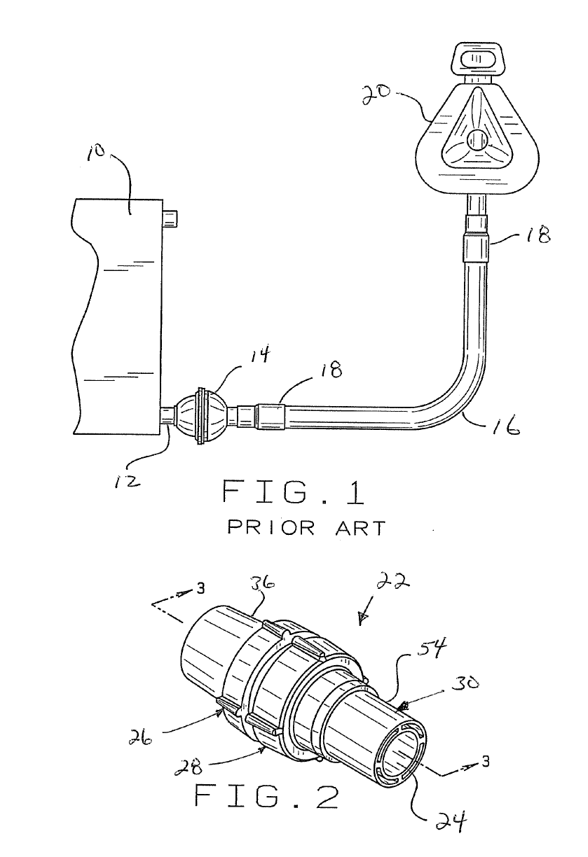

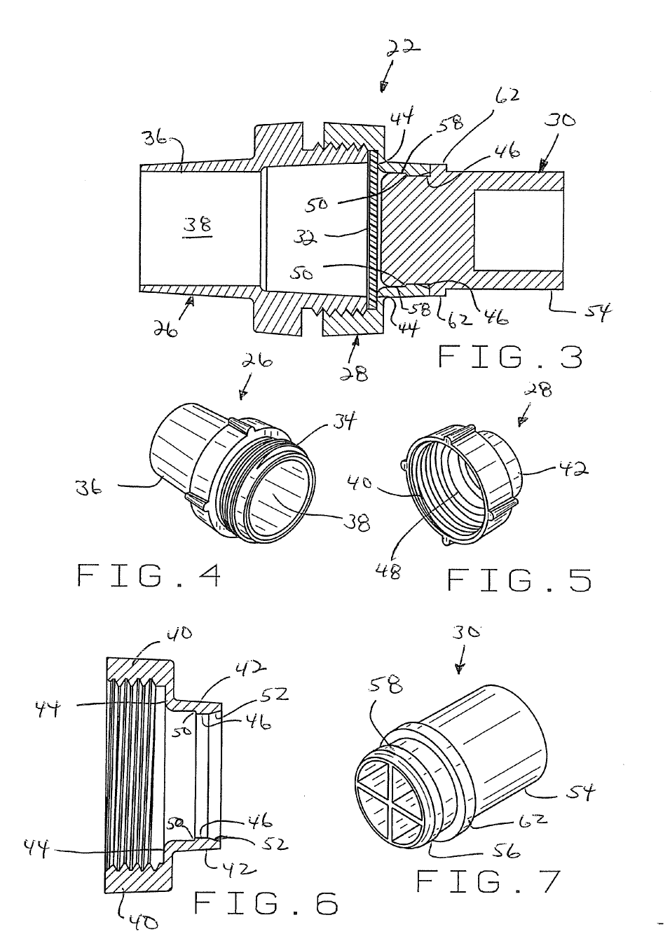

Referring to the drawings more particularly by reference numbers where in like numerals refer to like parts, numeral 22 in FIGS. 2 and 3 identify one embodiment of a swivel filter assembly constructed according to the teachings of the present invention. The swivel filter assembly 22 can be constructed so as to be compatible for attachment to any suitable type of fitting associated with a wide variety of different types of CPAP or other sleep apnea equipment as well as with a wide variety of different types of respiratory or pressure breathing systems including oxygen concentrators and ventilators. Although the specific applications discussed herein are directed to sleep apnea equipment, it is recognized and anticipated that the present swivel filter assembly can be utilized with a wide variety of different types of pressure or breathing equipment where ambient air or any other gas source such as oxygen needs to be filtered before such gas supply reaches the patient. It is also recognized that the swivel filter assembly constructed according to the teachings of the present invention can likewise be fashioned into a variety of different sizes and shapes other than those illustrated herein and that the other components associated with the present assembly may likewise be correspondingly shaped to conform to the shape of the overall assembly without departing from the teachings and the practice of the present invention.

The swivel filter assembly 22 illustrated in FIGS. 2 and 3 includes an overall generally cylindrically shaped assembly having a passageway 24 extending completely therethrough, the assembly 22 including a first member or plug member 26, a second member or nut member 28, a third member or swivel member 30, and a filter member 32 as best illustrated in FIG. 3. Each of the component members 26, 28 and 30 are shaped and configured so as to be cooperatively removably engageable with each other as will be hereinafter further explained. As best illustrated in FIG. 3, the filter member 32 is held in operative position over the passageway 24 by attachment of the nut member 28 to the plug member 26. Filter member 32 will purge the air flow passing therethrough and remove bacteria, dust and other contaminants associated with the air flow as it passes through the swivel filter assembly.

As best illustrated in FIGS. 3 and 4, the plug member 26 is shown as being substantially cylindrical in shape and includes a threaded portion 34 and a tubular portion 36. The external threads associated with the threaded portion 34 are adapted to cooperatively mate with the internal threads associated with nut member 28 as will be hereinafter further explained. The tubular portion 36 associated with plug member 26 is likewise adapted for cooperatively mating with an outlet fitting associated with a typical CPAP machine or other sleep apnea equipment as well as other respiratory and/or breathing equipment including oxygen concentrators and ventilators. Tubular portion 36 can be sized and shaped to cooperatively engage the appropriate outlet fitting associated with the particular type of equipment to which the present swivel filter assembly 22 will be attached. Still further, tubular portion 36 is also adaptable for mating with one end portion of appropriate tubing or hose such as the tubing 16 illustrated in FIG. 1 to be used with the CPAP or other equipment, the opposite end portion of such tubing being adaptable for mating with the outlet fitting associated with such equipment. The plug member 26 has a passageway 38 extending completely therethrough, the passageway 38 forming a portion of the overall passageway 24 which extends through the swivel filter assembly 22.

As best shown in FIGS. 3, 5 and 6, the nut member 28 is likewise substantially cylindrical in overall shape and includes an internally threaded portion 40 and a smaller tubular portion 42. The internally threaded portion 40 is adaptable for cooperatively engaging the threaded portion 34 of plug member 26. As best illustrated in FIG. 6, the average diameter of the tubular portion 42 is smaller than the average diameter of the internally threaded portion 40 thereby defining a circumferential flange or lip 44 where nut portions 40 and 42 mate with each other. As a result, the area, cavity, or internal space defined by the internally threaded portion of nut member 28 is greater than the area, cavity or internal space formed by the tubular portion 42 of nut member 28. Also, the tubular portion 42 includes a projection 46 which extends inwardly towards the center of the passageway 48 extending through nut member 28, the projection 46 forming a circumferential lip or shoulder portion 50 on the side closest to the internally threaded portion 40, the opposite side of projection 46 being bevelled or chamfered as at 52 as well be hereinafter further explained. The passageway 48 extending completely through nut member 28 likewise forms a portion of the passageway 24 extending through the overall assembly 22.

As best illustrated in FIGS. 3, 7 and 8, the swivel member 30 includes a first tubular portion 54 and a second smaller tubular portion 56. The second tubular portion 56 includes a projection 58 extending radially outwardly as best illustrated in FIGS. 7 and 8 which is adapted to mate with shoulder portion 50 associated with nut member 28. The leading edge portion 60 of projection 58 is likewise beveled or chamfered so as to enable the tubular portion 56 of swivel member 30 to be inserted within tubular portion 42 of nut member 28 so as to forceably push circumferential projection 58 beyond projection 46 associated with nut member 28 such that the trailing edge portion of projection 58 mates with and abuts lip or shoulder portion 50. The beveled edge 60 of swivel member 30 as well as the beveled edge 46 of nut member 28 facilitate the insertion of tubular portion 56 within tubular portion 42. Once projection 58 is positioned and located adjacent the shoulder portion 50 as best illustrated in FIG. 3, swivel member 30 is free to rotate 360° within the tubular portion 42 of nut member 28 thereby providing the swivel feature associated with the present assembly 22.

The lip or shoulder portion 50 of nut member 28 engages the projection 58 associated with swivel member 30 and prevents swivel member 30 from being removed and/or disengaged from nut member 28. The diameter of tubular portion 54 is selected so as to be compatible with coupling to or engaging standard tubing associated with a typical CPAP system or other sleep apnea system or other respiratory or pressure breathing systems such as the CPAP system illustrated in FIG. 1. The tubular portion 54 of swivel member 30 is therefore designed to be insertably positioned within compatible tubing such as the tubing 16 illustrated in FIG. 1, engagement being accomplished either by a friction fit or through the use of conventional adapters associated with such tubing. The swivel member 30 may likewise optionally include an additional optional circumferential projection 62 spaced from projection 58 as best illustrated in FIGS. 7 and 8, the projection 62 being positioned and located so as to abut the terminal end portion of tubular portion 42 associated with nut member 28 when swivel member 30 is cooperatively engaged with nut member 28. As best illustrated in FIG. 3, it is recognized that the projection 46 associated with nut member 28 will be positioned and located within the circumferential space 64 defined by and between projections 58 and 62, the projection 46 being free to rotate within the space 64 thereby providing the swivel feature of the present assembly 22.

The swivel member 30 likewise includes a passageway 66 extending through tubular portions 54 and 56, the passageway 66 likewise forming a portion of the overall passageway 24 extending through the overall assembly 22. Structural gridwork in the form of members 68 and 70 extend across the opening 66 to tubular portion 56 so as to provide support for filter member 32 when positioned thereagainst as will be hereinafter further explained. It is recognized and anticipated that the support members 68 and 70 can take on a wide variety of different configurations other than the specific configuration illustrated in FIG. 7.

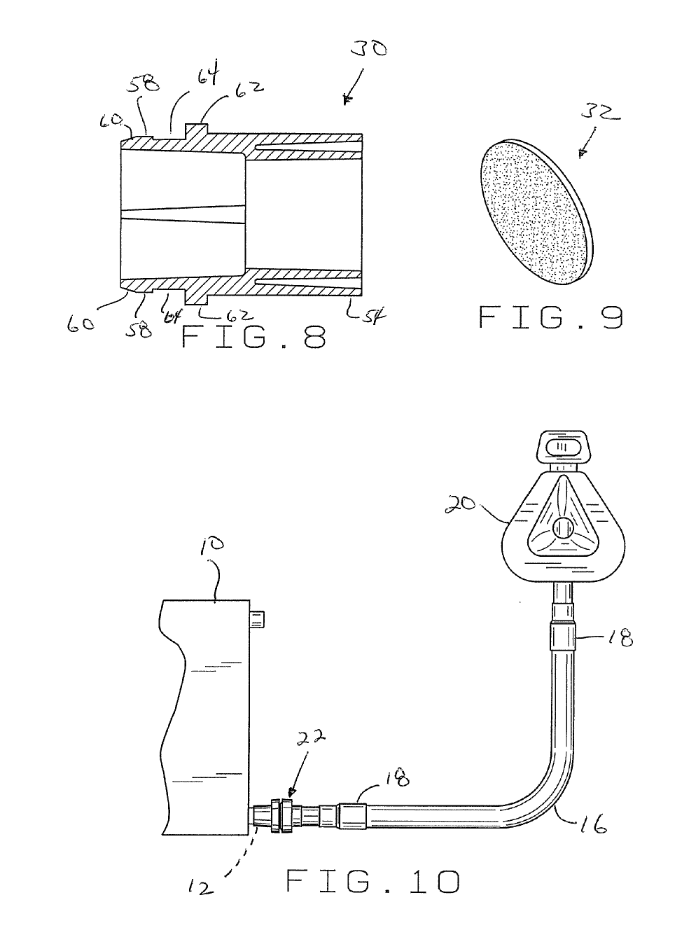

Once the swivel member 30 is cooperatively engaged with the nut member 28, the subassembly of members 28 and 30 can then be threadedly engaged with plug member 26. Prior to such engagement, the filter member 32 as best illustrated in FIGS. 3 and 9 is positioned within the space or cavity formed by the internally threaded tubular portion 40 adjacent the shoulder portion 44 as best illustrated in FIG. 3. The filter member 32 is sized and shaped to be compatible with and to fit within the space or cavity formed by tubular portion 40. Although the filter member 32 is shown as being circular or cylindrical in FIG. 9 because of the substantially cylindrical shape of members 26 and 28, it is recognized that the filter member 32 can take on a wide variety of different sizes and shapes so long as the filter member can be held in operative position when the members 26 and 28 are engaged with each other. With the swivel member 30 engaged with the nut member 28, the support structure formed by support members 68 and 70 provide additional support at the start of the opening 66 for filter member 32 thereby preventing the filter member 32 from being pushed or otherwise collapsed and forced through the opening 66 associated with swivel member 30. As a result, the circumferential shoulder 44 and the gridwork structure of members 68 and 70 provide adequate support for holding and retaining filter member 32. Still further, when plug member 26 is threadedly engaged with nut member 28, the terminal end portion of the externally threaded tubular portion 34 engages the circumferential periphery of filter member 32 and forceably retains and/or wedges the periphery of the filter member 32 against the shoulder portion 44 of nut member 28 thereby fixedly holding the filter member 32 in operative position across passageway 66 and 24 thereby filtering the air as it passes through the filter assembly 22 enroute to a patient. Because the filter member 32 is held in operative position through the cooperative engagement of plug member 26 with nut member 28, replacement of the filter member at routine intervals, or when the filter element becomes dirty and no longer functional within certain perimeters, can be easily accomplished. The filter member 32 can be easily removed and replaced by simply disengaging the plug member 26 from the nut member 28, removing the used filter member 32 and replacing such filter member with a new filter member, and thereafter cooperatively re-engaging plug member 26 with nut member 28. This makes for quick and easy replacement of the filter member 32 when needed.

Since the swivel member 30 is likewise cooperatively engageable with the nut member 28, replacement of one or both of these components is likewise easily accomplished. In fact, since all of the components of the present filter assembly 22, namely, members 26, 28, 30 and filter member 32 are all easily removably attachable as described above, any one or several of these components can be easily replaced.

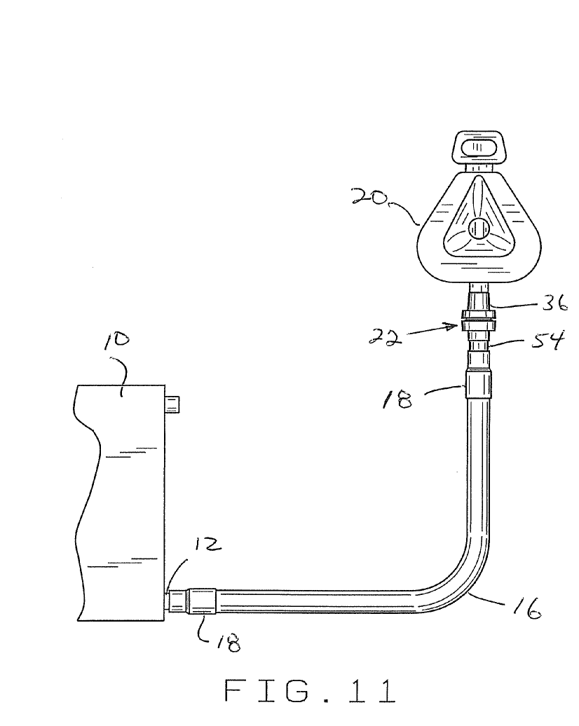

FIGS. 10 and 11 illustrate operative use of the present swivel filter assembly 22. As illustrated in FIG. 10, the present filter assembly 22 is incorporated into a typical CPAP system adjacent the CPAP equipment. In the particular embodiment illustrated in FIG. 10, the tubular portion 36 associated with plug member 26 is cooperatively engaged with the outlet fitting associated with a typical CPAP machine such as machine 10. The tubular portion 54 associated with swivel member 30 is thereafter cooperatively engaged with conventional CPAP tubing such as the tubing 16 illustrated in FIG. 10. The opposite end portion of tubing 16 is then connected in a conventional manner to the interface mask 20 which will be used by the patient for receiving the positive pressure air flow from the CPAP machine 10. An optional swivel fitting can likewise be attached to the mask 20 and to the opposite end portion of the tubing 16 to further facilitate easy rotation of the tubing 16 adjacent the mask so as to prevent binding of the tubing and to minimize forces applied to the head and nostrils of the patient due to normal tossing and turning of the patient during sleep. This optional swivel fitting may be incorporated into the mask 20, or it may be a separate fitting as previously explained.

FIG. 11 illustrates another CPAP system wherein the present swivel filter assembly 22 is incorporated into the overall system adjacent the interface mask 20. In this particular embodiment, the tubular portion 36 associated with plug member 26 is designed and shaped so as to be cooperatively engageable with a typical mask swivel or inlet valve or coupling associated with a wide variety of different types of mask systems whereas the tubular portion 54 associated with swivel member 30 can be easily attached to one end portion of conventional CPAP tubing. It is also recognized that, in certain applications, tubular portion 36 of plug member 26 may likewise be adapted for attachment to one end portion of conventional CPAP tubing and that the tubular portion 54 of swivel member 30 may be adapted for attachment to the mask swivel or inlet valve or coupling.

As previously explained, although the present swivel filter assembly 22 has been described with respect to use with a CPAP sleep apnea system, it is recognized and anticipated that the present swivel filter assembly can be utilized with a wide variety of different sleep apnea equipment including BiPAP, Bi-level, Bi-flex, VPAP and other systems, and it is recognized and anticipated that the present swivel filter can be utilized in a wide variety of other applications including use with oxygen concentrators, ventilators, other respiratory type equipment, and other pressure and/or breathing equipment wherein patient interface equipment such as masks are utilized to provide air, oxygen or other gases to a patient for a wide variety of different reasons. As explained above, the present swivel filter assembly 22 combines a filter assembly with a swivel fitting and provides free movement and rotation to the tubing or hose coupled to the present assembly due to head movement of the patient, whether asleep or awake. The present assembly 22 also minimizes forces applied to the interface head gear and the face area of the patient due to patient head movement relative to the hose or tubing and the pressure breathing equipment to which it is attached.

It is also recognized and anticipated that the nut member 28 and the swivel member 30 may be formed as an integral, one-piece unit thereby reducing the overall number of individual components. In this particular aspect of the present invention, the present filter assembly would include first and second members and a filter member. The first member includes a first passageway extending therethrough and has one end portion adaptable for coupling to a source for providing air or other gas to the first member, and has its opposite end portion engageable with the second member. In this embodiment, the first member is comparable to plug member 26 although its overall configuration including its size and shape may be different. The second member includes one end portion adaptable for engagement to the first member, and has its opposite end portion engageable with tubing adaptable for conveying the air or other gas away from the second member. Importantly, the opposite end portion of the second member is rotatable thereby enabling the tubing to freely rotate when attached thereto. This rotatability provides the swivel feature of the present invention. The second member, as stated above, is a combination of members 28 and 30 formed into an integral, one-piece unit. The second member likewise includes a passageway extending therethrough and, when engaged with the first member, the passageways through the first and second members lie in communication with each other for allowing air or other gas to pass completely therethrough. In addition, the second member likewise includes a space or cavity for receiving the filter member, the filter member extending across the passageway extending through the overall assembly when the first and second members are engaged with each other. This embodiment reduces the total number of components associated with the present assembly; it is easier to manipulate; it is easier to engage and disengage for replacing the filter element; and it is more cost effective.

It is also anticipated that the various components of the present swivel filter assembly 22, such as members 26, 28 and 30 can be made using an injection molded plastic resin, although other materials may likewise be utilized. Still further, it is also recognized that the overall dimensions of the present filter assembly as well as the specific shape and configuration of the various members associated therewith are also subject to wide variations and may be sized and shaped into a wide variety of different sizes and configurations so as to be compatible with a particular application for which it will be used, or to conform with any space limitations associated with such applications without impairing the teachings and practice of the present invention. Although the present swivel filter assembly 22 is illustrated as being substantially cylindrical, except for the cooperatively threaded engagement means associated with the plug member 26 and the nut member 28, other portions of these members can likewise take on other shapes such as square, rectangular and so forth.

The tubular portion 36 is illustrated as being substantially cylindrical in shape and adaptable for engaging a corresponding outlet fitting associated with a CPAP machine or other suitable equipment. It is recognized and anticipated that the tubular extension 36 could likewise be modified to adapt for connection to any suitable type of outlet fitting associated with any appropriate equipment depending upon the particular application involved. In similar fashion, the tubular portion 54 associated with swivel member 30 is likewise illustrated as being substantially cylindrical in shape and adaptable for engaging corresponding tubing for connection to an interface mask or other interface equipment. It is likewise recognized and anticipated that the tubular extension 54 could also be modified to adapt for connection to any suitable type of tubing or adapter associated therewith depending upon the particular application involved including connection to the inlet connection associated with an interface mask or other interface equipment. Still further, although threaded portions 34 and 40 are shown as being cooperatively engageable, it is recognized and anticipated that other cooperatively engageable means other than threaded means could likewise be utilized in association with members 26 and 28. It is also recognized that the tubular portion 34 of plug member 26 could be internally threaded instead of externally threaded and that the internally threaded portion 40 of nut member 28 could be externally threaded without departing from the spirit and scope of the present invention. Other variations and modifications to the various components comprising the present structures are also contemplated.

Thus, there has been shown and described a novel swivel filter assembly which is adaptable for installation into a wide variety of sleep apnea systems as well as a wide variety of other pressure or breathing systems including oxygen concentrators and ventilators, which filter assembly fulfils all of the objects and advantages sought therefore. Many changes, modifications, variations and other uses and applications of the present invention will, however, become apparent to those skilled in the art after considering this specification and the accompanying drawings. All such drawings, modifications, variations and other uses and applications which do not depart from the spirit and scope of the present invention are deemed to be covered by the present invention which is limited only by the claims which follow.

What is claimed is:

1. A filter assembly comprising:
a first member having a first passageway extending therethrough;
a second member having a second passageway extending therethrough; and
a filter member;
said first member having one end portion adaptable for coupling to a source for providing air or other gas to said first member and having its opposite end portion engageable with said second member;
said second member having one end portion engageable with said first member and having its opposite end portion engageable with tubing adaptable for conveying air or other gas away from said second member, the opposite end portion of said second member being rotatable thereby enabling the tubing to rotate freely when attached thereto;
said first and second passageways being in communication with each other when said first and second members are cooperatively engaged with each other;
said second member further including a space for receiving said filter member, said filter member extending across said first and second passageways when said first and second members are engaged with each other.

2. The filter assembly defined in claim 1 wherein the engagement of said first member with said second member holds said filter member in operative position within the space of said second member for receiving said filter member.

3. The filter assembly defined in claim 1 wherein said first and second members are threadedly engageable with each other.

4. The filter assembly defined in claim 1 wherein a portion of said second passageway is larger than other portions of said second passageway.

5. A filter assembly comprising:
a first member having a first passageway extending therethrough;
a second member having a second passageway extending therethrough;
a third member having a third passageway extending therethrough; and
a filter member;
said first member having one end portion adaptable for engagement with either an air or other gas supply source or tubing for supplying air or other gas to said first member, the opposite end portion of said first member being engageable with said second member;
said second member having one end portion engageable with said first member and having its opposite end portion engageable with said third member, said second member having a space associated therewith for receiving said filter member, said filter member being positioned across said second passageway;
said third member having one end portion engageable with said second member and having its opposite end portion engageable with tubing adaptable for conveying air or other gas away from said third member, said third member being freely rotatable relative to said second member when engaged therewith;
said first, second and third passageways being in communication with each other when said first, second and third members are engaged with each other.

6. The filter assembly defined in claim 5 wherein said filter member is held in operative position within said second member by engagement of said first member with said second member.

7. The filter assembly defined in claim 5 wherein said first, second and third members are substantially cylindrical in shape.

8. The filter assembly defined in claim 7 wherein the diameter of said third passageway is smaller than the diameter associated with at least a portion of said second passageway.

9. The filter assembly defined in claim 5 wherein said first and second members are threadedly engageable with each other.

10. The filter assembly defined in claim 5 wherein said second member includes an inwardly extending projection and wherein said third member includes an outwardly extending projection, said projections being positioned in abutting relationship to each other when said third member is engaged with said second member.

11. The filter assembly defined in claim 5 wherein the one end portion of said third member engageable with said second member includes at least one member for providing support to said filter member when said filter member is received within the space associated with said second member and said second and third members are cooperatively engaged with each other.

12. The filter member defined in claim 5 wherein the air or other gas supply source is a sleep apnea device for supplying air under pressure to a patient.

13. A filter assembly comprising:
a plug member having a passageway extending therethrough;
a nut member having a passageway extending therethrough;
a swivel member having a passageway extending therethrough; and
a filter member for insertion within said nut member;
said plug member having one end portion adaptable for coupling to a supply of air or other gas source and having its opposite end portion cooperatively engageable with said nut member;
said nut member having one end portion cooperatively engageable with said plug member and having its opposite end portion engageable with said swivel member, said nut member having a space associated therewith for receiving said filter member, said filter member being positioned across the passageway extending through said nut member;
said swivel member having one end portion engageable with said second member and having its opposite end portion engageable with tubing adaptable for conveying air or other gases away from said swivel member, said swivel member being freely rotatable relative to said nut member when engaged therewith;
the passageways associated with said plug member, nut member and swivel member being in communication with each other when said members are engaged with each other.

14. The filter assembly defined in claim 13 wherein said nut member includes a shoulder portion, the periphery of said filter member abutting said shoulder portion when said filter member is received within the space associated with said nut member.

15. The filter assembly defined in claim 13 wherein said filter member is held within the space associated with said nut member when said plug member is engaged with said nut member.

16. The filter assembly defined in claim 14 wherein the periphery of said filter member is fixedly held in abutting relationship to said shoulder portion when said plug member is engaged with said nut member.

17. A filter member for use with sleep apnea equipment including a device for providing air under pressure and associated tubing comprising:
a first member having a first passageway extending therethrough;
a second member having a second passageway extending therethrough; and
a filter member;
said first member having one end portion adaptable for coupling to the device for providing air under pressure to said first member and having its opposite end portion engageable with said second member;
said second member having one end portion engageable with said first member and having its opposite end portion engageable with the associated tubing, the opposite end portion of said second member being rotatable thereby enabling the tubing to rotate freely when attached thereto;
said first and second passageways being in communication with each other when said first and second members are engaged with each other;
said second member further including a space for receiving said filter member, said filter member extending across said first and second passageways when said first and second members are engaged with each other.

18. A filter assembly for use with sleep apnea equipment including a device for providing air under pressure and associated tubing comprising:
a first member having a first passageway extending therethrough;
a second member having a second passageway extending therethrough;
a third member having a third passageway extending therethrough; and
a filter member;
said first member having one end portion adaptable for coupling to the device for providing air under pressure to said first member, the opposite end portion of said first member being engageable with said second member;
said second member having one end portion engageable with said first member and having its opposite end portion engageable with said third member, said second member having a space associated therewith for receiving said filter member, said filter member being positioned across said second passageway;
said third member having one end portion engageable with said second member and having its opposite end portion engageable with the associated tubing, said third member being freely rotatable relative to said second member when engaged therewith;
said first, second and third passageways being in communication with each other when said first, second and third members are engaged with each other.

19. A filter assembly comprising:
a first member, a second member, and a filter member;
said first member having one end portion adaptable for coupling to a source for providing air or other gas to said first member and having its opposite end portion engageable with said second member;
said second member having one end portion engageable with said first member and having its opposite end portion engageable with tubing adaptable for conveying air or other gas away from said second member, the opposite end portion of said second member being freely rotatable thereby enabling the tubing to freely rotate when attached thereto;
said second member having a space adaptable for receiving said filter member;
said assembly having a passageway extending therethrough when said first and second members are engaged with each other for allowing air or other gas to flow therethrough, said filter member being positioned across said passageway at an intermediate location therealong to remove contaminants from the air or other gas as the air or other gas passes through said assembly.

20. A filter assembly comprising:
a first member, a second member, a third member, and a filter member;
said first member having one end portion adaptable for coupling to a source for providing air or other gas to said first member, the opposite end portion of said first member being engageable with said second member;
said second member having one end portion engageable with said first member and having its opposite end portion engageable with said third member, said second member having a space associated therewith for receiving said filter member;
said third member having one end portion engageable with said second member and having its opposite end portion engageable with tubing adaptable for conveying air or other gas away from said third member, said third member being freely rotatable relative to said second member when engaged therewith;
said assembly having a passageway extending therethrough when said first, second and third members are engaged therewith for allowing air or other gas to pass therethrough, said filter member being positioned across said passageway at an intermediate location therealong to remove contaminants from the air or other gas as the air or other gas passes through said assembly.

21. A filter assembly comprising:
a first member, a second member and a filter member;
said first member having one end portion engageable with tubing adaptable for conveying air or other gas to said first member and having its opposite end portion engageable with said second member;
said second member having one end portion engageable with said first member and having its opposite end portion adaptable for coupling to a mask for providing air or other gas to a patient, the opposite end portion of said second member being freely rotatable thereby enabling said assembly to freely rotate when attached to the mask;
said second member having a space adaptable for receiving said filter member; said assembly having a passageway extending therethrough when said first and second members are engaged with each other for allowing air or other gas to flow therethrough, said filter member being positioned across said passageway at an intermediate location therealong to remove contaminants from the air or other gas as the air or other gas passes through said assembly.

22. A filter assembly comprising:
a first member, a second member, a third member, and a filter member;
said first member having one end portion engageable with tubing adapted for conveying air or other gas to said first member, the opposite end portion of said first member being engageable with said second member;
said second member having one end portion engageable with said first member and having its opposite end portion engageable with said third member, said second member having a space associated therewith for receiving said filter member;
said third member having one end portion engageable with said second member and having its opposite end portion adaptable for coupling to a mask for providing air or other gas to a patient, said third member being freely rotatable relative to said second member when engaged therewith;
said assembly having a passageway extending therethrough when said first, second and third members are engaged therewith for allowing air or other gas to pass therethrough, said filter member being positioned across said passageway at an intermediate location therealong to remove contaminants from the air or other gas as the air or other gas passes through said assembly.

23. A filter assembly comprising:
a first member, a second member and a filter member;
said first member having one end portion adaptable for coupling to a mask for providing air or other gas to a patient and having its opposite end portion engageable with said second member;
said second member having one end portion engageable with said first member and having its opposite end portion engageable with tubing adaptable for conveying air or other gas to said assembly, the opposite end portion of said second member being freely rotatable thereby enabling said assembly to freely rotate when attached to the tubing;
said second member having a space adaptable for receiving said filter member; said assembly having a passageway extending therethrough when said first and second members are engaged with each other for allowing air or other gas to flow therethrough, said filter member being positioned across said passageway at an intermediate location therealong to remove contaminants from the air or other gas as the air or other gas passes through said assembly.

24. A filter assembly comprising:
a first member, a second member, a third member, and a filter member;
said first member having one end portion adaptable for coupling to a mask for providing air or other gas to a patient, the opposite end portion of said first member being engageable with said second member;
said second member having one end portion engageable with said first member and having its opposite end portion engageable with said third member, said second member having a space associated therewith for receiving said filter member;
said third member having one end portion engageable with said second member and having its opposite end portion engageable with tubing adaptable for conveying air or other gas to said assembly, said third member being freely rotatable relative to said second member when engaged therewith;
said assembly having a passageway extending therethrough when said first, second and third members are engaged therewith for allowing air or other gas to pass therethrough, said filter member being positioned across said passageway at an intermediate location therealong to remove contaminants from the air or other gas as the air or other gas passes through said assembly.
